(19) United States
(12) Patent Application Publication
(10) Pub. No.: US 2010/0100718 A1
(43) Pub. Date: Apr. 22, 2010

(54) In-the-flow security services for guested virtual machines

(75) Inventor: Kattiganehalli Y. Srinivasan, Princeton Junction, NJ (US)

Correspondence Address: KING & SCHICKLI, PLLC, 247 NORTH BROADWAY, LEXINGTON, KY, 40507, US

(73) Assignee: Novell, Inc.

(21) Appl. No.: 12/288,433

(22) Filed: Oct. 20, 2008

(51) Int. Cl. G06F 15/177

(52) U.S. Cl. 713/1

(57) ABSTRACT

Methods and apparatus provide security to guest virtual machines configured on a hardware platform. A plurality of I/O domains are also configured on the hardware platform and connect between each of the guest virtual machines and a network connected to the hardware platform or remote or local storage available to the hardware platform. In this manner, the I/O domains are configured in the flow of the guest virtual machines as they utilize available resources, for instance, and are able to filter network or block level traffic, respectively. Representatively, one filter analyzes packets exchanged to and from the network, while the other filter analyzes internal traffic and may be a block-tap, stackable driver, virus scanning application, etc. Also, the guested virtual machines communicate with the I/O domains by way of a shared memory transport. Still other features contemplate drivers, operating systems, and computer program products, to name a few.

### FIELD OF THE INVENTION

Generally, the present invention relates to computing devices and computing environments involving security services. Particularly, although not exclusively, it relates to security services for virtual machines guested on a common hardware platform, especially security in a flow from the virtual machines to a connected network or available storage. Other features contemplate computing arrangements, drivers, operating systems, and computer program products, to name a few.

### BACKGROUND OF THE INVENTION

As presently exists, physical servers provide a myriad of services, such as those found with application servers, web servers, email servers, etc. Just as servers have a diversity of function, however, they also have a diversity of configuration, such as in their operating systems, hardware device drivers, storage interfaces, file systems, applications, etc. Also, for security, it is typically the situation that servers are guarded from computing attacks by a dedicated firewall appliance between the servers and a connected network (e.g., the Internet), or a personal firewall implemented as an internal service within the operating system of the server. Problematically, the former requires additional infrastructure and capital expenditure for such devices, and the latter insists on tight correlation to the server's operating system configuration. Also, the former is limited by how many devices it can effectively service and the latter does not transfer well to other servers having vastly different operating systems, storage interfaces, files systems, etc.

With the advent of virtual computing, the former's problems are further exacerbated since a single hardware platform will often guest many such virtual devices, and the latter's problems are complicated as each guested device carries its own operating system, drivers, interfaces, applications, etc. Intuitively, each also causes an increase in the code footprint necessary to provide security in the virtual environment, and adds costly overhead in the form of needing, multiple uniquely configured personal firewalls, as well as spam filters, virus scanners, etc. It also adds overhead in coordinating/managing it all. Further, upon infection of an operating environment, it is unclear what level of confidence a party can have in any of its security functions, applications, appliances, etc.

Accordingly, a need exists in the art of providing computing security for less costly overhead, especially in the form of a consolidated security infrastructure with ease of coordination and management. It is also relevant to do so in the context of a minimal code footprint as well as in a guest agnostic fashion per the nuances of many virtual devices on a single hardware platform. Appreciating users, enterprises, etc. may already own or have access to virus scanning applications, packet sniffing software, or other security devices, the need further extends to providing compelling end-user value by utilizing existing products, to the extent possible, thereby avoiding the development and purchasing of wholly new products and concomitant processes/techniques. Further, upon compromise of a security measure, the need should contemplate simple and effective troubleshooting techniques to isolate the problem. Naturally, any improvements along such lines should further contemplate good engineering practices, such as ease of implementation, unobtrusiveness, stability, etc.

### SUMMARY OF THE INVENTION

The foregoing and other problems become solved by applying the principles and teachings associated with the hereinafter described in-the-flow security services for virtual machines guested on a hardware platform. At a high level, (Input/Output) I/O domains also configured on the hardware platform exist “in-the-flow” between the guested virtual machines and a connected network or available storage and filter network traffic or block level traffic, respectively. In this manner, the guested virtual machines have security guarantees comparable to stand-alone firewall appliances, but with a consolidated infrastructure.

In certain embodiments, the I/O domains connect between each of the plurality of guest virtual machines and a network connected to the hardware platform or remote or local storage available to the hardware platform. In this manner, the I/O domains are configured in the flow of the guest virtual machines as they utilize available resources, for instance, and are able to filter for security reasons the network or block level traffic, respectively. Representatively, one filter analyzes packets exchanged to and from the network, while the other filter analyzes internal traffic and may be a block-tap, stackable driver, virus scanning application, etc. Also, the guested virtual machines communicate with the I/O domains by way of a shared memory transport of a hypervisor layer of the hardware platform. Further, the I/O domains host back-end drivers that communicate with the physical device drivers of the hardware platform and the guested virtual machines host front-end drivers that communicate with the back-end drivers.

To minimize the code footprint of such a design, the I/O domains representatively consist of a minimalist Linux operating system sufficient to simply host a packet or block filter and necessary back-end drivers. Also, the design contemplates guest agnostic I/O domains that avoid unique or dependent configuration per a guest operating system, a guest file system, etc., of the guested virtual machines. Still other features contemplate computing arrangement, particular I/O paths, operating systems, and computer program products, to name a few.

In a particular apparatus embodiment, a hardware platform typifies a computing server having a processor, memory, and access to remote or local storage, and is able to be connected to a computing network. A plurality of virtual machines, each operating as an independent guest computing device on the processor and memory by way of scheduling control from a hypervisor layer, access the network and/or remote or local storage during use, as is typical. A plurality of I/O domains, however, also exist as virtual machines on the server and filter network and block level traffic between each of the guest virtual machines and the network or the remote or local storage, respectively. Also, the hypervisor includes the common I/O path by which the I/O domains and the guested virtual machines communicate. In certain embodiments, the path typifies the form of a secure, shared memory transport.

Consequently, the I/O domains provide the guested virtual machines with security comparable to stand-alone firewall appliances, but with a consolidated infrastructure. They also consolidate physical security appliances while preserving the security isolation provided by the physical security appliances, i.e., they prevent server sprawl. Even further, such a configuration may be possible to minimize license requirements per a single hardware platform since each platform guests many virtual devices, but with commonality for network or block filtering.

Executable instructions loaded on one or more computing devices for undertaking the foregoing are also contemplated as are computer program products available as a download or on a computer readable medium. The computer program products are also available for installation on a network appliance or individual computing devices.

These and other embodiments of the present invention will be set forth in the description which follows, and in part will become apparent to those of ordinary skill in the art by reference to the following description of the invention and referenced drawings or by practice of the invention. The claims, however, indicate the particularities of the invention.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIGS. 1 and 2 are diagrammatic views in accordance with the present invention of representative computing environments for in-the-flow security services for pluralities of virtual machines guested on a hardware platform.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and apparatus are hereinafter described for in-the-flow security services for guested virtual machines.

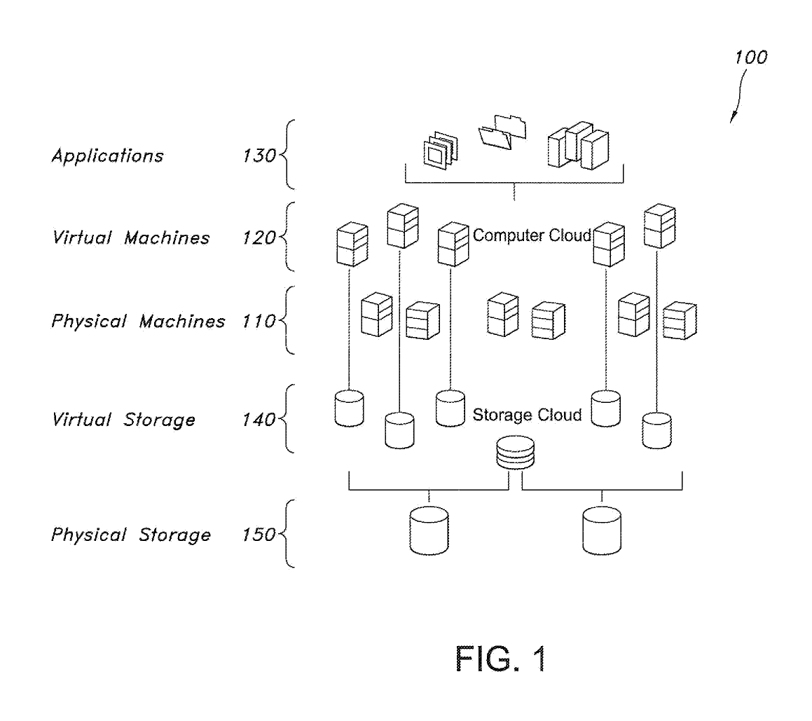

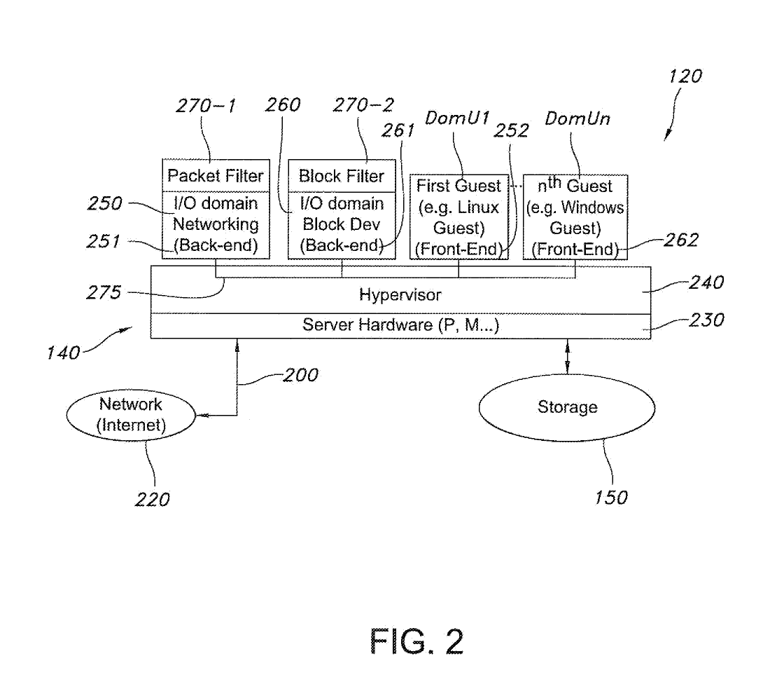

With reference to FIGS. 1 and 2, a representative computing system environment 100 includes pluralities of physical machines 110 hosting one or more virtual machines 120. In turn, each virtual machine includes its own guest operating system (e.g., Linux, Windows, Netware, Unix, etc.), applications 130, file systems, etc. According to various partitions, the application data, boot data, or other data, executable instructions, etc., are virtually stored 140 on available physical storage 150 that is either remote or local to the physical machines, and such is typical in a virtual environment.

In more detail, the physical machines representatively include a computing device in the form of a server. It can be of a traditional type, such as a grid or blade server, and can fulfill any future-defined or traditional role, such as a web server, email server, database server, file server, application server etc. In network, it is arranged to communicate 200 with one or more other computing devices or networks, and skilled artisans readily understand the configuration. For example, the server has ports and may use wired, wireless or combined connections, to other devices/networks and may be direct or indirect connections. If direct, they typify connections within physical or network proximity (e.g., intranet). If indirect, they typify connections such as those found with the internet, satellites, radio transmissions, or the like, and either scenario is given nebulously as element 220. In this regard, other contemplated items include other servers, routers, peer devices, modems, Tx lines, satellites, microwave relays or the like. The connections may also be local area networks (LAN), wide area networks (WAN), metro area networks (MAN), etc., that are presented by way of example and not limitation. The topology is also any of a variety, such as ring, star, bridged, cascaded, meshed, or other known or hereinafter invented arrangement.

In configuration, the physical server can be arranged in a variety of ways, including virtual representations such as according to the Xen architecture for Novell, Inc., (the assignee of the invention). Namely, the architecture can include a multiplicity of domains (I/O Networking, I/O Block Dev, or any of guest virtual machines domU1 . . . domUn) and a variety of operating systems (Host OS or Guest OS) (e.g., Linux, Windows, Netware, Unix, etc.). In turn, each can be configured on a common hardware platform 230, with an intervening Xen or other hypervisor layer 240. Also, the hardware platform embodies physical I/O and platform devices, memory (M) and a processor (P), such as a CPU, Disk, USB, etc., while the hypervisor (also known as a “virtual machine monitor,” which is the virtual interface to the hardware and virtualizes the hardware), is the lowest and most privileged layer and performs scheduling control between the virtual machines as they task the resources of the hardware platform, storage, network, etc. The hypervisor also manages conflicts, among other things, caused by operating system access to privileged machine instructions. The hypervisor can also be type 1 (native) or type 2 (hosted), and skilled artisans understand the terminology.

Leveraging this arrangement, however, security services are provided to the guested virtual machines (domain U, 1 . . . n) by way of the I/O domains 250,260 ‘in-the-flow’ between the guested virtual machines and a connected network 220 or between the guested virtual machines and available storage 150. In other words, the I/O domains serve to filter network traffic or block level traffic, respectively, as the guested virtual machines task the resources of the network, such as by making requests to and from the Internet, or task the block level resources of storage. Also, each I/O domain includes a filter 270 and each is designed to perform different tasks. Representatively, one filter 270-1 analyzes packets exchanged to and from the guested virtual machines and network, while the other filter 270-2 analyzes internal traffic and may typify a block-tap, a stackable driver, a virus scanning application or any other type of filter useful in this regard. Appreciating users, enterprises, etc. may already own or have access to virus scanning applications, packet sniffing software, or other security devices that could fulfill the role of filter 270, the filters themselves can be existing products thereby avoiding the development and purchasing of wholly new products and concomitant processes/techniques.

In addition, the use of existing technology allows for the creation of an I/O domain 250, 260 by way of type I hypervisors, such as Xen. In this regard, the I/O domains are further able to control hardware at a desired granularity. For instance, it is possible to have a single I/O domain controlling all physical I/O devices attached to the server, but in the representative embodiment, it is chosen to split the I/O domains into two domains. Namely, I/O domain 250 is chosen to consolidate all network drivers, while I/O domain 260 consolidates all block device drivers. In this way, the partitioning of in-the-flow services can be made even more granular whereby, for example, each network I/O domain could control a single network interface card (NIC). The choice, naturally, is guided by the level of desired security isolation. Also, each I/O domain is a stripped down or minimalist version of a Linux operating system having just enough system to host the desired physical device drivers and the needed in-the-flow services. In this manner, each I/O domain is made small which niizes the overall code footprint of such a design, thereby enhancing the software availability while minimizing the security attack surface.

It should also be noticed that the two illustrated guest virtual machines, i.e., the Linux guest Dom U1 and the Windows guest Dom Un, communicate with the I/O domains 250, 260 by way of a common I/O path 275. In this instance, the common path is a secure shared memory transport 275 provided, typically, by hypervisors 240. Also, the I/O domains host the back-end drivers 251, 261 that talk to the physical device drivers of the hardware platform, while the front-end drivers 252, 262 are hosted within the context of the guested virtual machines and communicate with the back-end drivers via the shared memory transport 275.

Naturally, this framework can be used to support a number of in-the-flow services including security services listed earlier. In other embodiments, the network I/O domain can also be used to host other perimeter services such as Proxy cache etc.

In any embodiment, skilled artisans will appreciate that enterprises can implement some or all of the foregoing with humans, such as system administrators, computing devices, executable code, or combinations thereof. In turn, methods and apparatus of the invention further contemplate computer executable instructions, e.g., code or software, as part of computer program products on readable media, e.g., disks for insertion in a drive of computing device, or available as downloads or direct use from an upstream computing device. When described in the context of such computer program products, it is denoted that executable instructions thereof, such as those bundled as components, modules, routines, programs, objects, data structures, etc., perform particular tasks or implement particular abstract data types within various structures of the computing system which cause a certain function or group of function, and enable the configuration of the foregoing.

Although the foregoing has been described in terms of specific embodiments, one of ordinary skill in the art will recognize that additional embodiments are possible without departing from the teachings of the present invention. This detailed description, therefore, and particularly the specific details of the exemplary embodiments disclosed, is given primarily for clarity of understanding, and no unnecessary limitations are to be implied, for modifications will become evident to those skilled in the art upon reading this disclosure and may be made without departing from the spirit or scope of the invention. Relatively apparent modifications, of course, include combining the various features of one or more figures with the features of one or more of other figures.

1. In a computing system environment, a method of providing security to a plurality of guest virtual machines configured on a hardware platform, comprising:
configuring a plurality of I/O domains on the hardware platform including configuring one of the I/O domains between each of the plurality of guest virtual machines and a network connected to the hardware platform and configuring another of the I/O domains between said each of the plurality of guest virtual machines and storage available to the hardware platform.

2. The method of claim 1, further including configuring a hypervisor of the hardware platform as a layer in which said each of the plurality of guest virtual machines communicate through the plurality of I/O domains.

3. The method of claim 1, further including configuring the one of the I/O domains as packet filter between said each of the plurality of guest virtual machines and the network connected to the hardware platform to analyze packets exchanged to and from the network.

4. The method of claim 1, further including configuring the another of the I/O domains as a filter between said each of the plurality of guest virtual machines and the storage available to the hardware platform, the filter being a block-tap, a stackable driver or a virus scanning application.

5. The method of claim 1, further including configuring each of the plurality of I/O domains with back-end drivers that communicate with physical device drivers of the hardware platform.

6. The method of claim 5, further including configuring said each of the plurality of guest virtual machines with front-end drivers that communicate with the back-end drivers of the each of the plurality of I/O domains.

7. The method of claim 1, wherein the configuring the plurality of I/O domains on the hardware platform further includes configuring the plurality of I/O domains independently of an operating system of said each of the plurality of guest virtual machines.

8. In a computing system environment, a method of providing security to a plurality of guest virtual machines configured on a hardware platform having a hypervisor, comprising:
configuring a plurality of I/O domains on the hardware platform including configuring one of the I/O domains as a filter between each of the plurality of guest virtual machines and a network connected to the hardware platform and configuring another of the I/O domains as a filter between said each of the plurality of guest virtual machines and storage available to the hardware platform; and
configuring by way of the hypervisor said each of the plurality of guest virtual machines to communicate with the network or storage through the plurality of I/O domains.

9. The method of claim 8, further including configuring a memory transport of the hypervisor for said communication between said each of the plurality of guest virtual machines and the network or storage.

10. The method of claim 8, further including configuring said one of the I/O domains with all drivers of the network.

11. The method of claim 8, further including configuring said another of the I/O domains with all block device drivers.

12. The method of claim 8, further including configuring the filter between said each of the plurality of guest virtual machines and the network connected to the hardware platform as a packet filter to analyze packets exchanged to and from the network.

13. The method of claim 8, further including configuring the filter between said each of the plurality of guest virtual machines and the storage available to the hardware platform as a block-tap, a stackable driver or a virus scanning application.

14. A computing server, comprising:
a hardware platform including a processor, memory, the hardware platform able to be connected to a computing network and having access to remote or local storage;
a hypervisor layer on the hardware platform;
a plurality of guest virtual machines each operating as an independent guest computing device on the processor and memory by way of scheduling control from the hypervisor layer; and
a plurality of I/O domains wherein one of the I/O domains serves as a filter between each of the plurality of guest virtual machines and the computing network and another of the I/O domains serves as a second filter between said each of the plurality of guest virtual machines and the remote or local storage.

15. The computing server of claim 14, wherein the hypervisor layer further includes a shared memory transport that connects said each of the plurality of guest virtual machines to each of the plurality of I/O domains.

16. The computing server of claim 14, wherein the plurality of I/O domains include back-end drivers that communicate with physical device drivers of the hardware platform.

17. The computing server of claim 16, wherein said each of the plurality of guest virtual machines include front-end drivers that communicate with the back-end drivers.

18. The computing server of claim 14, wherein the filter is a packet filter to analyze packets exchanged to and from the network.

19. The computing server of claim 14, wherein the second filter is a block-tap, a stackable driver or a virus scanning application.

20. A computing server, comprising:
a hardware platform including a processor, memory, the hardware platform able to be connected to a computing network and having access to remote or local storage;
a hypervisor layer on the hardware platform;
a plurality of guest virtual machines each operating as an independent guest computing device on the processor and memory by way of scheduling control from the hypervisor layer;
one I/O domain connected between each of the plurality of guest virtual machines and the computing network; and
another I/O domain connected between said each of the plurality of guest virtual machines and the remote or local storage.

21. The computing server of claim 20, wherein said each of the plurality of guest virtual machines has an operating system that is a same or different operating system than other of the plurality of guest virtual machines.

22. The computing server of claim 20, wherein the one I/O domain or the another I/O domain includes a minimalist Linux operating system.

23. The computing server of claim 20, wherein the hypervisor layer is a Xen hypervisor including a shared memory transport.

24. The computing server of claim 23, wherein the shared memory transport said connects the one I/O domain and said each of the plurality of guest virtual machines and said connects the another I/O domain and said each of the plurality of guest virtual machines.

25. A computing server, comprising:
a hardware platform including a processor, memory, the hardware platform able to be connected to a computing network and having access to remote or local storage;
a hypervisor layer on the hardware platform;
a plurality of guest virtual machines each operating as an independent guest computing device on the processor and memory by way of scheduling control from the hypervisor layer;
a plurality of I/O domains wherein one of the I/O domains filters traffic between each of the plurality of guest virtual machines and the computing network and another of the I/O domains filters traffic between said each of the plurality of guest virtual machines and the remote or local storage; and
a common I/O path between the plurality of I/O domains and said each of the plurality of guest virtual machines.

26. The computing server of claim 25, wherein the common I/O path is in the hypervisor layer.

27. A computer program product available as a download or on a computer readable medium for loading on a computing server in a computing system environment to provide security to a plurality of guest virtual machines configured on the computing server, the computer program product having executable instructions to enable configuring a plurality of I/O domains on the computing server including configuring one of the I/O domains between each of the plurality of guest virtual machines and a network connectable to the computing server and configuring another of the I/O domains between said each of the plurality of guest virtual machines and storage available to the computing server.

28. The computer program product of claim 27, further including executable instructions to configure the one of the I/O domains with a packet filter between said each of the plurality of guest virtual machines and the network to analyze packets exchanged to and from the network during use.

29. The computer program product of claim 27, further including executable instructions to configure the another of the I/O domains with a filter between said each of the plurality of guest virtual machines and the storage, the filter being a block-tap, a stackable driver or a virus scanning application.

30. The computer program product of claim 27, further including executable instructions to configure an I/O path of a hypervisor of the computing server as a common path between said each of the plurality of guest virtual machines and the plurality of I/O domains.
